(19) United States
(12) Patent Application Publication
(10) Pub. No.: US 2019/0219897 A1
(43) Pub. Date: Jul. 18, 2019

(54) Optically Aligned Camera Module Assembly Using Soldering

(71) Applicant: Integrated Micro-Electronics, Inc., Binan (PH)

(72) Inventors: Christopher Lawrence S. Tiongson, Pasig City (PH); John Roderick L. Javate, Binan (PH)

(21) Appl. No.: 16/250,181

(22) Filed: Jan. 17, 2019

Related U.S. Application Data
(60) Provisional application No. 62/618,351, filed on Jan. 17, 2018.

(51) Int. Cl. G03B 17/14; H04N 5/225

(52) U.S. Cl. CPC G03B 17/14; H04N 5/2254; H04N 5/2252; H04N 5/2253

(57) ABSTRACT

A camera module includes a front housing assembly having a lens and a lens holder, wherein the lens includes a plurality of optical elements, and wherein the lens holder includes a plurality of pins extending from a mating surface of the lens holder; an image sensor mounted to a substrate, wherein the substrate includes openings configured to receive the plurality of pins, and wherein the substrate is secured to the plurality of pins at a fixed position using solder, and wherein at the fixed position, the image sensor has optimal focus and alignment relative to the lens; and a back housing assembly attached to the front housing assembly via the mating surface of the lens holder.

### CROSS-REFERENCE TO RELATED APPLICATION

This application claims the benefit of U.S. Patent Application No. 62/618,351, filed Jan. 17, 2018, the entire contents of which are hereby incorporated by reference.

### TECHNICAL FIELD

The present invention relates generally to camera modules, and more particularly, to optically aligned camera modules for use in high-precision applications.

### BACKGROUND

As the proliferation of technologies relating to semi-autonomous and autonomous control of equipment and machines continues, and in particular to advancements in automotive applications, there is an increased need for accuracy and precision of the camera modules used by underlying vision detection systems.

Camera modules used with vision applications generally include a lens assembly optically coupled to an image sensor mounted on a printed circuit board (PCB). Critical applications, such as advanced driver assistance or autonomous driving systems, require accurate focusing and alignment of the lens assembly with respect to the image sensor. Such accuracy is achieved by applying multiple-axis focusing and alignment procedures during assembly of the camera module.

Known techniques for assembling camera modules include a quick curing adhesive that is dispensed onto the PCB in an annular pattern that surrounds the image sensor. This adhesive is positioned to mate with a mating area on a front housing of the camera module. A gripper is used to move the PCB toward the front housing until the uncured adhesive contacts the mating area. The gripper then manipulates the PCB in 5 or 6 axes while an output of the image sensor is monitored until a precise alignment is achieved between the image sensor and the lens assembly. Thereafter, the adhesive is snap-cured to secure the placement of the image sensor relative to the lens assembly so that the gripper can release PCB. A back housing of the camera module is attached to the front housing to complete the assembly.

While this construction results in a camera whose optical axis is aligned with a fixation axis of the camera, the snap-cure adhesive used to fix the position of the image sensor with respect to the lens assembly requires post curing to achieve optimal bonding strength. However, during post curing, there is significant shrinkage of the adhesive, which causes a shift in the position of PCB such that the image sensor is no longer optimally aligned with the lens assembly. To compensate for the shift, prior to the adhesive being snap-cured, the position of the PCB is adjusted according to a predicted amount of shrinkage. The shrinkage, however, is not always uniform, which adversely impacts the yield of the camera module during production.

### SUMMARY

According to an embodiment of the invention, there is provided a camera module that includes a front housing assembly having a lens and a lens holder, wherein the lens includes a plurality of optical elements, and wherein the lens holder includes a plurality of pins extending from a mating surface of the lens holder; an image sensor mounted to a substrate, wherein the substrate includes openings configured to receive the plurality of pins, and wherein the substrate is secured to the plurality of pins at a fixed position using solder, and wherein at the fixed position, the image sensor has optimal focus and alignment relative to the lens; and a back housing assembly attached to the front housing assembly via the mating surface of the lens holder.

According to another embodiment of the invention, there is provided a camera module that includes a lens assembly integrally formed with a lens holder, wherein a back surface of the lens holder includes a plurality of pins extending perpendicularly therefrom, wherein a distal end of the plurality of pins has a surface substantially parallel to the back surface of the lens holder; a substrate having an image sensor disposed thereon and a plurality of openings aligned to receive the plurality of pins, wherein the substrate is adjusted to a position of optimal alignment and focus between the image sensor and the lens, wherein the substrate is fixed at the optimal position by depositing solder balls to the surface of the plurality of pins and applying a selective soldering technique to melt and flow the solder around the plurality of pins and onto solder pads on the substrate; and a cover attached to the back surface of the lens holder.

### BRIEF DESCRIPTION OF THE DRAWINGS

One or more embodiments of the invention will hereinafter be described in conjunction with the appended drawings, wherein like designations denote like elements, and wherein:

FIG. 1 illustrates an exploded view of an exemplary camera module assembly used in accordance with the method disclosed herein;

FIG. 2 illustrates an exploded side view of the exemplary camera module assembly shown in FIG. 1;

FIG. 3 illustrates a cross-sectional view of an assembled camera module according to an exemplary embodiment of the method disclosed herein; and

FIGS. 4A-4F illustrate cross-sectional views of a camera module assembly process being performed vertically in accordance with the method disclosed herein.

### DETAILED DESCRIPTION OF THE ILLUSTRATED EMBODIMENT(S)

The system and method described below are directed to assembling a camera module having a printed circuit board and a lens assembly, and more particularly, to a method of securing the printed circuit board at its optimal position relative to the lens assembly. The disclosed method uses a selective soldering process that fixes the position of the printed circuit board such that it remains stable after alignment. That is, once secured, there is no shift in position (i.e., the alignment) of the printed circuit board after soldering. The disclosed method eliminates the adhesive curing step used in known assembly processes, resulting in a shorter overall processing time. In addition, the disclosed soldering method produces a robust camera module construction that can withstand more severe jarring and vibration as compared to an adhesive-attached printed circuit board.

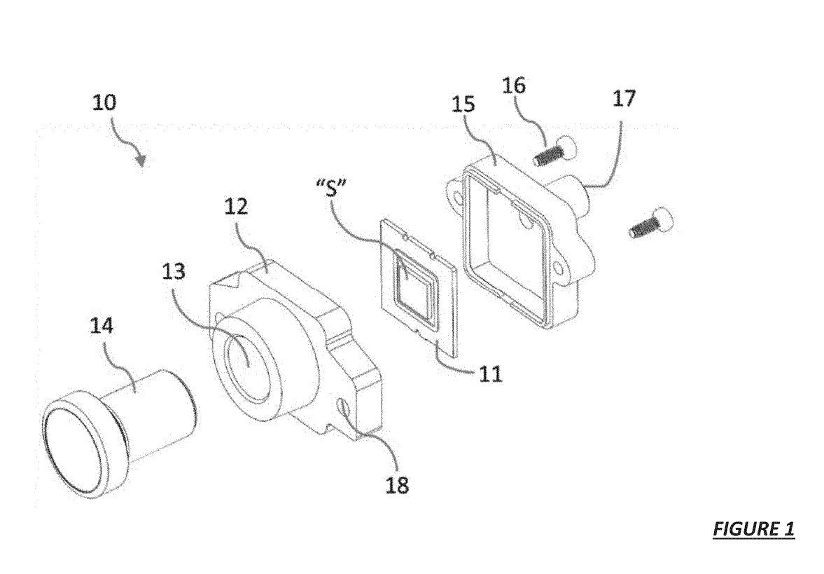

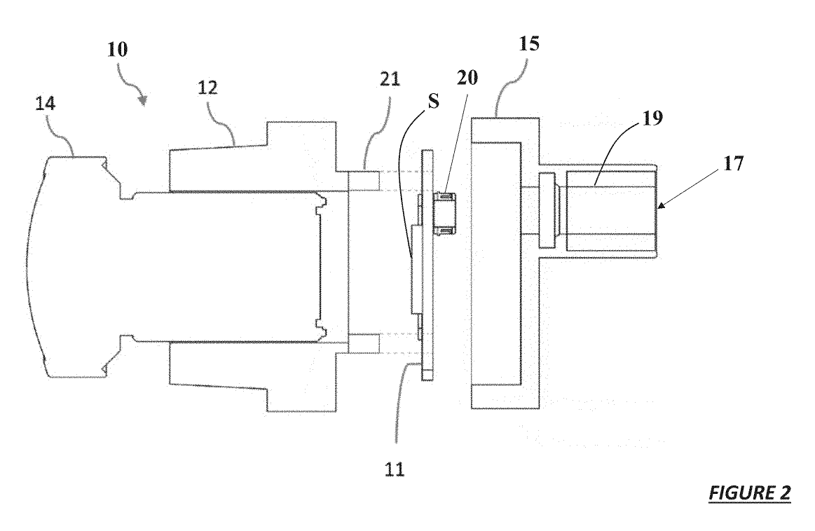

FIGS. 1 and 2 illustrate exploded views of the camera module 10, and FIG. 3 illustrates a cross sectional view of a camera module 10 assembled according to the method disclosed herein. The camera module 10 includes an image sensor S mounted on a substrate 11, which in one embodiment, is a printed circuit board (PCB). The PCB 11 may include other circuits, for example, for power supply regulation, noise reduction, circuit protection and image processing. In one embodiment, the image sensor S is an integrated circuit. In one non-limiting example, the image sensor S is a CMOS type device that may be a) a package-type (e.g. a chip scale package (CSP) or ball grid array (BGA)) and mounted to the PCB 11 using a surface mount technology (SMT) process, or b) a bare-die type and mounted to the PCB 11 using a chip on board process.

The camera module 10 also includes a front housing 12 (also referred to as lens holder) with a receiving lens bore 13 to which a lens objective 14 is attached. The lens objective 14 is an integrated lens assembly with multiple internal lens elements. In some embodiments, lens objective 14 is integrated into the front housing 12. The lens objective 14 and the front housing 12 are mechanically aligned and secured in mating engagement via, for example, an adhesive. The PCB 11 is then powered-up and actively-aligned with respect to the front housing 12 and the lens objective 14 that have been previously mated. A back housing or cover 15 with an integrated connector 19 completes the camera module assembly. Connector 19 is accessible through connector hole 17 and mates with terminals 20, which are mounted at a back side of the PCB 11.

The assembly, via the front housing 12 and the back housing 15, is held together with screws 16 as shown in FIG. 1. Alternatively, an adhesive may be used to attach the back housing 15 to front housing 12, or when both front 12 and back 15 housing are made of plastic, they can be attached to each other using ultrasonic welding. Mounting of the camera module 10 is done through mounting holes 18.

As shown in FIGS. 2 and 3, the camera module 10 further includes pins 21 that are incorporated into, and made an integral part of, the front housing 12. The pins 21 extend from a mating surface of the front housing 12 and are configured to mate with cut-outs or openings 22 on the PCB 11. The pins 21 are used in conjunction with solder 23 to fix the position of PCB 11 during the alignment process. In one non-limiting embodiment, the pins 21 and the corresponding holes on PCB 11 can be implemented in 2 up to 4 different locations depending on the size of the PCB 11. In one non-limiting embodiment, the pins 21 are made from metal. In one particular example, the pins 21 are tin-plated and can be either a) molded in place when the front housing 12 is made of plastic, or b) pressed-fit in place when the front housing 12 is made of metal.

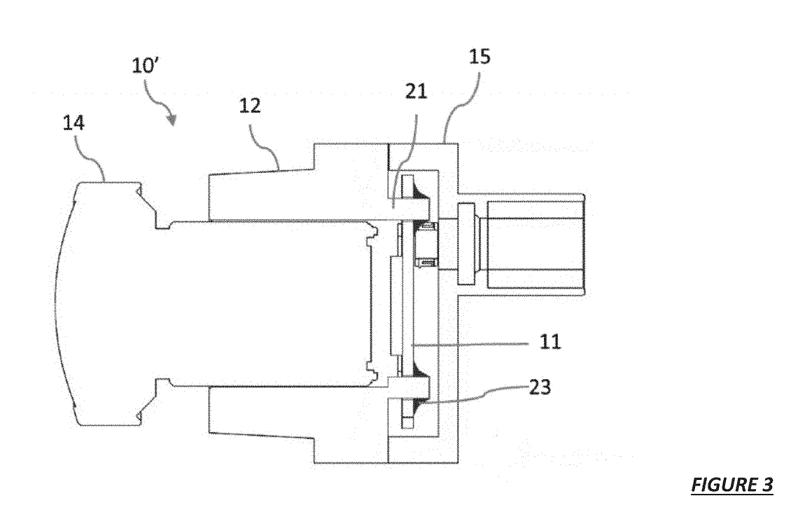

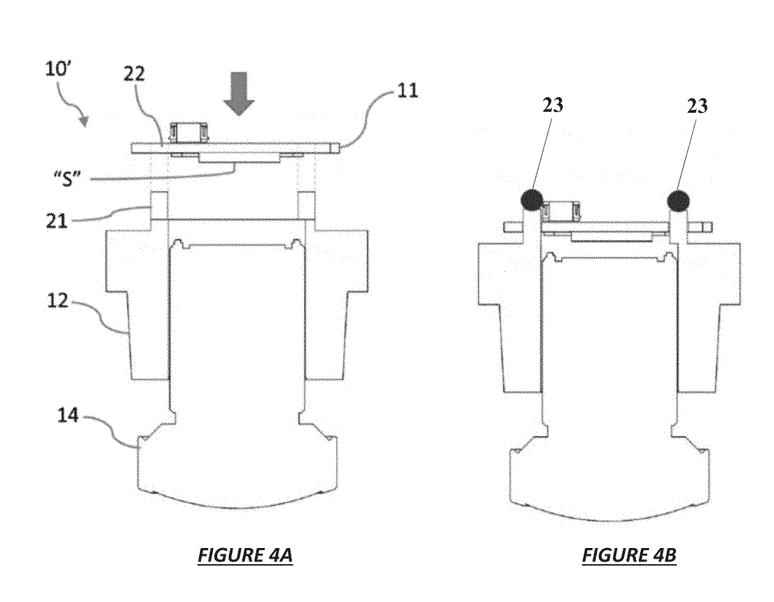

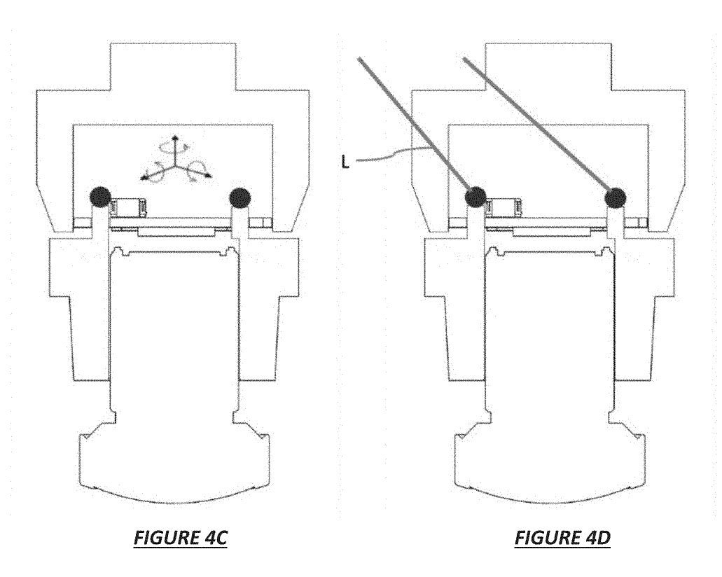

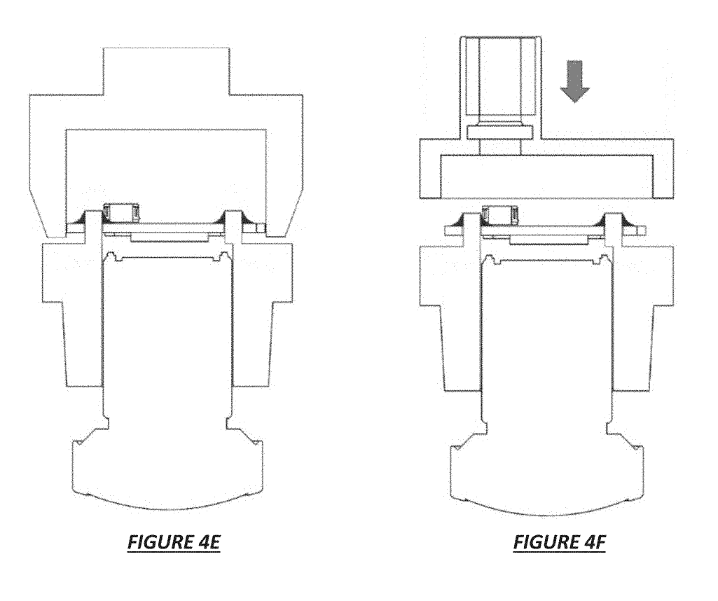

FIGS. 4A-4E illustrate cross-sectional views at various stages of a camera module assembly being performed vertically in accordance with the disclosed method. FIG. 4A illustrates the PCB 11 containing image sensor S being lowered onto the front housing 12 with the pins 21 on the front housing 12 being aligned with openings 22 on PCB 11. In FIG. 4B, with the PCB 11 resting on the front housing 12, solder paste 23 in the shape of balls is deposited on top of the pins 21. In one embodiment, the solder paste is automatically dispensed by a machine in an amount sufficient to enable the melted solder to flow down the pins 21 by gravity and form an adequate fillet with respect to the pad on the opening(s) in the PCB 11.

FIG. 4C illustrates a multi-axis positioning device having a gripper G that is configured to adjust the position of PCB 11 in 5 or 6 axes while an output of the image sensor S is monitored until a precise alignment between the image sensor S and the lens 14 is achieved. That is, the PCB 11 is manipulated by the positioning device in 5 or 6 axes until the image sensor S has optimal focus and alignment relative to the lens 14. Stated differently, the PCB 11 is manipulated by the positioning device unit it has arrived at a position with respect to the lens that will provide a maximum focus score across the field of view of the sensor and the closest alignment of the sensor with respect to the center of a test target. In FIG. 4D, with the gripper G holding PCB 11 at its optimal position, a “snap” selective soldering technique is used to melt the solder balls 23 deposited on top of pins 21. The “snap” selective soldering technique is used to melt the solder paste 23 deposited on top of the pins 21. In this technique a method of localized heating is applied such that only the solder paste 23, the pins 21, and the pads on the PCB 11 are raised to a reflow temperature profile while the surrounding components on the PCB 11 are left unaffected by the process. More particularly, selective soldering is accomplished through a precise and momentary firing of the solder balls 23 with a laser beam L. The melted solder 23 naturally flows down, and attaches to, the sides of the pins 21 while also attaching to solder pads located on PCB 11. Stated differently, the melted solder 23 flows down the outer surface of the pins 21 to a joint between the PCB substrate 11 and the pins 21. The final solder profile is illustrated in FIG. 4E. After a few moments, the solder hardens and the gripper G can release the PCB 11 so that the back housing 15 can be attached as shown in FIG. 4F.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A camera module comprising:
a front housing assembly having a lens and a lens holder, wherein the lens includes a plurality of optical elements, and wherein the lens holder includes a plurality of pins extending from a mating surface of the lens holder;
an image sensor mounted to a substrate, wherein the substrate includes openings configured to receive the plurality of pins, and wherein the substrate is secured to the plurality of pins at a fixed position using solder, and wherein at the fixed position, the image sensor has optimal focus and alignment relative to the lens; and
a back housing assembly attached to the front housing assembly via the mating surface of the lens holder.

2. The camera module of claim 1, wherein the lens is integrated into the lens holder.

3. The camera module of claim 1, wherein the lens and the lens holder are integrally formed.

4. The camera module of claim 1, wherein the lens and the lens holder are optically-center aligned and secured in mating engagement via an adhesive.

5. The camera module of claim 1, wherein the substrate includes circuitry configured to provide at least one of power supply regulation, noise reduction, circuit protection, and image processing.

6. The camera module of claim 1, wherein the substrate is a printed circuit board.

7. The camera module of claim 1, wherein the lens holder is in mating engagement with the substrate via the plurality of pins.

8. The camera module of claim 1, wherein the solder is attached to side surfaces on the plurality of pins and to solder pads on the substrate.

9. The camera module of claim 1, wherein the substrate is soldered to the plurality of pins by applying solder paste to end surfaces of the plurality of pins and melting the solder paste so that the solder paste attaches to side surfaces of the plurality of pins and to the substrate.

10. The camera module of claim 1, wherein the solder is deposited to top surfaces of the plurality of pins and melted so that the solder flows to a joint between the substrate and the plurality of pins.

11. The camera module of claim 10, wherein the solder is solder paste deposited onto the top surface of the plurality of pins in the shape of balls.

12. The camera module of claim 1, wherein the plurality of pins are metal pins.

13. The camera module of claim 1, wherein the plurality of pins is integrally formed in the lens holder.

14. The camera module of claim 1, wherein the optimal focus and alignment between the image sensor and the lens is achieved in five or six axes using a multi-axis positioning device.

15. A camera module comprising:
a lens assembly integrally formed with a lens holder, wherein a back surface of the lens holder includes a plurality of pins extending perpendicularly therefrom, wherein a distal end of the plurality of pins has a surface substantially parallel to the back surface of the lens holder;
a substrate having an image sensor disposed thereon and a plurality of openings aligned to receive the plurality of pins, wherein the substrate is adjusted to a position of optimal alignment and focus between the image sensor and the lens, wherein the substrate is fixed at the optimal position by depositing solder balls to the surface of the plurality of pins and applying a selective soldering technique to melt and flow the solder around the plurality of pins and onto solder pads on the substrate; and
a cover attached to the back surface of the lens holder.

16. The camera module of claim 15, wherein the lens assembly and the lens holder are optically-center aligned and secured in mating engagement via an adhesive.

17. The camera module of claim 15, wherein the substrate includes circuitry configured to provide at least one of power supply regulation, noise reduction, circuit protection, and image processing.

18. The camera module of claim 15, wherein the substrate is a printed circuit board.

19. The camera module of claim 15, wherein the lens holder is in mating engagement with the substrate via the plurality of pins.

20. The camera module of claim 1, wherein the solder flows to a joint between the substrate and the plurality of pins.

21. The camera module of claim 1, wherein the plurality of pins are metal pins.

22. The camera module of claim 1, wherein the plurality of pins is integrally formed in the lens holder.

23. The camera module of claim 1, wherein the optimal focus and alignment between the image sensor and the lens is achieved in five or six axes using a multi-axis positioning device.
